(19) United States
(12) Patent Application Publication
(10) Pub. No.: US 2012/0251749 A1
(43) Pub. Date: Oct. 4, 2012

(54) HEAT SEALABLE MONOAXIALLY ORIENTED PROPYLENE-BASED FILM WITH DIRECTIONAL TEAR

(75) Inventors: MARK S. LEE, NORTH KINGSTOWN, RI (US); HAROLD EGON KOEHN, NORTH KINGSTOWN, RI (US); EMILIO COLETTA, NORTH KINGSTOWN, RI (US); MATTHEW H. BROWN, WAKEFIELD, RI (US); KEUNSUK P. CHANG, NORTH KINGSTOWN, RI (US)

(73) Assignee: TORAY PLASTICS (AMERICA), INC., N. KINGSTOWN, RI (US)

(21) Appl. No.: 13/483,886

(22) Filed: May 30, 2012

Related U.S. Application Data
(63) Continuation-in-part of application No. 13/290,444, filed on Nov. 7, 2011.
Application No. 13/290,444 is a continuation-in-part of application No. 12/542,385, filed on Aug. 17, 2009.
(60) Provisional application No. 61/089,121, filed on Aug. 15, 2008.

(51) Int. Cl. C08L 23/12; B32B 15/085; C08L 23/16; B32B 1/02; B29C 47/00; C08L 23/20; B32B 27/08; B32B 27/32

(52) U.S. Cl. 428/35.2; 428/519; 428/451; 428/447; 428/462; 264/101; 264/210.1; 525/240

(57) ABSTRACT

A monoaxially oriented film including an ethylene-propylene impact copolymer and 3-15 wt % of a metallocene-catalyzed propylene-butene elastomer and 30-60 wt % of a crystalline propylene homopolymer which is oriented at least 3 times in the machine direction and exhibits excellent linear directional tear properties in the machine direction for retort pouch applications and has excellent heat seal performance both pre- and post-retorting. This film formulation and orientation is suitable for pouch applications requiring an “easy-tear” linear tear feature and excellent hermetic seal properties, particularly for retort pouches.

### CROSS-REFERENCE TO RELATED APPLICATIONS

This application is a continuation-in-part of U.S. patent application Ser. No. 13/290,444, filed Nov. 7, 2011, which is a continuation-in-part of U.S. patent application Ser. No. 12/542,385, filed Aug. 17, 2009, which claims the benefit of U.S. Provisional Patent Application Ser. No. 61/089,121, filed Aug. 15, 2008, the entire contents of which are incorporated herein by reference.

### FIELD OF THE INVENTION

This invention relates to a monoaxially oriented heat sealable propylene-based film which exhibits excellent sealability and directional tearability.

### BACKGROUND OF THE INVENTION

For the preservation and packaging of pre-cooked foods without particular preservation techniques such as freezing, pickling, salting, drying, or smoking, cans and retortable pouches have been routinely used. Such canning and retorting applications subject the food contents to high temperatures for short time periods which effectively cook the contents within the container and/or sterilize the contents such that the contents remain safely preserved until used by the consumer.

With the increasing cost of metals and metal processing, flexible retort pouches are becoming more popular as a cost-effective method to package such pre-cooked foods. Flexible retort pouches are lighter in weight, which saves in transportation costs. In addition, they have excellent printing characteristics and can provide more visual “pop” than paper labels for metal cans.

The typical retort pouch is a laminate of several films, typically constructed of a film that can be printed for the marketing of the food product; a barrier film to inhibit the diffusion of oxygen and moisture and thus prolong the shelf-life of the product; and a sealant film which provides hermetic seals which also helps preventingress of gases or microbes that could shorten the shelf-life of the product or cause spoilage. In addition, this sealant film must provide high seal strengths that can withstand the retorting process. Typically, this sealant film is a non-oriented, cast polypropylene or polyethylene-based film. During retorting, high temperatures are used to sterilize and/or cook the contents and pressure can build up within the pouch as a result of this heating. Thus, the sealant component of the pouch must be formulated to be able to withstand both the high temperatures and pressures that result from the retort process and thus, maintain the integrity of the pouch. Moreover, the formulation of the sealant component (as well as the other components of the pouch) must be compliant to food packaging regulations for retort applications such as stipulated by US Food and Drug Administration (FDA) 21 CFR 177. 1390, which specifies the materials that can be used to construct flexible retort packages and compliance guidelines for migratory testing.

However, the high seal strengths required for retort packaging also make it difficult for the consumer to open the pouch by hand, especially if the retort package is made of all polymeric films. Scissors or sharp implements must be used to open such pouches. To make the pouches more user-friendly, notches can be used to enable the consumer to easily initiate a tear and thus open the pouch. However, such a tear can easily result in “zippering” of the pouch whereby the tear is not uniformly parallel to the top edge of the pouch but can become vertical or diagonal to the top of the pouch and cause a potential loss or spillage of the contents during opening. To rectify this, some solutions involve perforating a tear-line with the notch in order to keep the tear directionally parallel to the top of the pouch and thus prevent zippering. These perforations are often accomplished using mechanical perforators or lasers. Some concerns using perforation techniques are not only additional cost, but also the potential compromising of barrier properties since these techniques are essentially perforating the pouch laminate.

Another method to impart directional tear properties could be to orient the cast polypropylene film typically used in retort applications. However, the process of orienting such a film—either uniaxially or biaxially—typically diminishes the seal properties in that the seal initiation temperature (SIT) of the film is raised and the overall seal strengths are weaker. Without being bound by any theory, this is believed to be due to the fact that the orientation process aligns the amorphous regions into a more ordered configuration, raising the Tg of the film, and thus, seal properties are poorer. This is why unoriented cast polypropylene works well as a sealant film versus, for example, biaxially oriented polypropylene film (BOPP) which generally functions poorly as a sealant film. (This is assuming that no coextruded random copolymer heat sealable resins are used as part of the BOPP film.) There is typically a minimum and maximum range for uni-axial orientation stretching in the machine direction (MDX): under 3.0 MDX, the film usually suffers from uneven stretching mark defects and over 7.0 MDX, processing stability can be difficult to maintain, as the film may be prone to breakage at this high orientation rate.

U.S. Pat. No. 6,541,086 describes a retort package design using an oriented polymer outer film (suitable for printing), an aluminum foil as a barrier film, a second oriented intermediate polymeric film, and a non-oriented polyolefin for the sealant film. Easy-tear functionality is added by surface roughening the two oriented polymer films and overlapping them in a particular formation. The particular specific order of laminating the films and the surface roughening by sandpaper provides for easy-tear properties and presumably directional tear, but this process involves additional films and extra steps to accomplish the desired tear properties.

U.S. Pat. No. 6,719,678 describes a retort package design using multiple film layers whereby the intermediate layers (“burst resistant layer”) are scored by a laser such that the score lines provide an easy-tear feature and a directional tear feature.

U.S. Pat. No. 6,846,532 describes a retort package design intended to reduce cost by enabling the reduction of layers from typically 4 plies to 3 plies. The heat sealable layer is a non-oriented cast polypropylene film and no directional tear properties are cited.

U.S. Pat. No. 5,756,171 describes a retort package design using multiple layers of films including polyolefin film layers intended to protect the inner barrier layer from hydrolysis effects. These polyolefin film layers include a rubber-type elastomer mixed into an ethylene-propylene copolymer. However, there are no directional properties cited.

U.S. Pat. No. 4,903,841 describes a retort package design that utilizes non-oriented cast polypropylene films as the sealable layers, which are surface-roughened or scored in a particular manner so as to impart directional tear properties.

U.S. Pat. No. 4,291,085 describes a retort package design using a non-drawn, non-oriented cast crystalline polypropylene film as the sealable layer with specific crystalline structure and orientation of the crystalline structures which must be less than 3.0. There are no directional tear properties cited.

U.S. Pat. No. 5,786,050 describes an “easy opening” pouch design which has as the inner ply (which contacts the pouch's contents) a sealant film including linear low density polyethylene; an intermediate layer composed of an oriented polyolefin with an MD/TD ratio of greater than 2; and an outermost layer of biaxially oriented PET or nylon film. The inner ply sealant of linear low density polyethylene is non-oriented. The specific orientation ratios of the intermediate film imparts easy-tear properties.

U.S. Pat. No. 4,834,245 describes a pouch design having a “tearing zone” using a mono-axially oriented film with a pair of notches aligned with the tearing direction and the direction of orientation of said film. The mono-axially oriented film which imparts the “tearing zone” is on the outside of the pouch and does not contact the pouch contents and is not designed or considered to be appropriate for heat-sealability.

U.S. patent application Ser. No. 11/596,776 describes a pouch design including a uni-directionally stretched film. The preferred embodiments describe a uni-directionally stretched polypropylene film or uni-directionally stretched polyethylene terephthalate film that imparts the easy tear property. The application is silent as the sealing properties of these layers or even which layer should be the sealant film.

### SUMMARY OF THE INVENTION

Described are monoaxially oriented heat sealable propylene-based films that exhibit excellent sealability and directional tearability. These films are well-suited as the sealable film component for retort pouch packaging applications. In addition, these films are highly suitable for packages that require hand-tearability and for that tear line to be controlled and consistent across the top of the pouch and parallel to the top of the pouch, without causing “zippering” of the pouch and subsequent potential loss of the contents. The films combine both excellent seal strengths and hermetic seals suitable for retorting and directional tear, obviating the need for perforation techniques to enable directional tear.

One embodiment is a monoaxially oriented film including a single layer (A) of an ethylene-propylene impact copolymer blended with an amount of metallocene-catalyzed propylene-butene elastomer and an amount of crystalline propylene homopolymer. An optional amount of metallocene-catalyzed ethylene-butene elastomer may be also blended into this single layer film. This layer (A) formulation is suitable for heat sealable applications, particularly for retort packaging applications. Another embodiment could include a laminate film in which a second polyolefin resin-containing layer (B) could be coextruded on one side of said layer (A). This second polyolefin resin-containing layer could be considered a core or base layer to provide the bulk strength of the laminate film. Preferably, this core layer (B) could also include an ethylene-propylene impact copolymer. Furthermore, in another embodiment, the laminate could further include a third polyolefin resin-containing layer (C) on the second polyolefin resin-containing core layer (B) opposite the side with the heat sealable layer (A). Other embodiments could incorporate additional layers interposed between the aforementioned layers.

Preferably, the heat sealable layer (A) includes an amount of an ethylene-propylene impact copolymer of about 10-30 wt % ethylene-propylene rubber content. The amount of impact copolymer including the (A)-layer is about 40-70 wt % of the layer. A component of the (A)-layer formulation is a minority amount of metallocene-catalyzed propylene-butene elastomer of about 15-30 wt % butene content. The amount of this propylene-butene elastomer used in the (A)-layer is about 3-15 wt % of the (A) layer. Another component of the (A)-layer is an amount of crystalline propylene homopolymer of about 30-60 wt % of the (A)-layer. An optional component of the (A)-layer formulation is the use of a minority amount of metallocene-catalyzed ethylene-butene elastomer of about 15-35 wt % butene. The amount of this optional amount of ethylene-butene elastomer used in the (A)-layer is up to 10 wt % of the (A)-layer.

This film layer (A) is then monoaxially oriented from 3-7 times in the machine direction, preferably 4-7 times, and more preferably 4.8 to 6.0 times. This monoaxial orientation imparts a directional tear property to the film. The resin formulation of the (A)-layer provides excellent seal initiation, seal strengths, and hermetic seal properties after monoaxial orientation, suitable for retort pouch applications.

In the embodiment of a 2-layer laminate film structure, the (A)-layer could include a sealant layer on one side of a core layer (B). Preferably, this core layer (B) includes a polyolefin resin-containing layer which in turn, includes a propylene homopolymer or propylene copolymer. More preferable is an ethylene-propylene impact copolymer of the same or similar type used as a component of the (A)-layer. The (A)-layer can be the same thickness as the (B) core layer, but preferably is thinner than the (B)-layer, about 5-50% of the total thickness of the (A) and (B) layers combined, more preferably 10-30% of the total thickness of the laminate film structure (A) and (B) layers combined. This core polyolefin resin-containing layer can also include an antiblock component selected from the group consisting of amorphous silicas, aluminosilicates, sodium calcium aluminum silicates, crosslinked silicone polymers, and polymethylmethacrylates to aid in machinability and winding. It can also be contemplated to discharge-treat the side of the core layer (B) opposite the heat sealable layer (A) in order to enhance that side for laminating via adhesives, etc. Discharge-treating can be done by any of several means well known in the art, such as corona, flame, plasma, or discharge-treatment in a controlled atmosphere of selected gases.

In the embodiment of a 3-layer laminate film structure, the third layer (C) would be disposed on the side of the core layer (B) opposite the heat sealable layer (A) and preferably includes a polyolefin resin-containing layer which in turn, includes a polyolefin selected from the group consisting of propylene homopolymer, copolymers, terpolymers, polyethylene and combinations thereof. This third polyolefin resin-containing layer can also include an antiblock component selected from the group consisting of amorphous silicas, aluminosilicates, sodium calcium aluminum silicates, crosslinked silicone polymers, and polymethylmethacrylates to aid in machinability and winding. The third polyolefin layer can also be a discharge-treated layer having a surface for lamination, metallizing, printing, or coating with adhesives or inks.

In the case of a film structure including only one single layer (or mono-layer), such as said heat sealable layer (A), it can be contemplated to discharge-treat one side of this layer for lamination, metallizing, printing, or coating, while leaving the opposite side untreated in order to maintain heat sealable properties. Discharge-treating this layer can result in the treated side having a narrower seal range due to crosslinking of the ethylene and butene constituents of the blend. Thus, at least one side must be left untreated in order to obtain the full and useful heat seal range. In the case of a 2-layer (or more; i.e. multi-layer) laminate structure wherein the sealable layer (A) is contiguous with a polyolefin core layer (B), it is preferable to discharge-treat the side of the core layer opposite the sealable layer (A) for purposes of laminating, printing, metallizing, coating, etc.

Discharge-treatment in the above embodiments can be accomplished by several means, including but not limited to corona, flame, plasma, or corona in a controlled atmosphere of selected gases. Preferably, in one variation, the discharge-treated surface has a corona discharge-treated surface formed in an atmosphere of CO₂ and N₂ to the exclusion of O₂. The laminate film embodiments could further include a vacuum-deposited metal layer on the discharge-treated layer's surface. Preferably, the metal layer has a thickness of about 5 to 100 nm, has an optical density of about 1.5 to 5.0, and includes aluminum. In one variation, the laminate film is an extruded laminate film.

Yet another embodiment, is a monoaxially oriented polyolefin film with a heat sealable layer of blends of ethylene-propylene impact copolymers with metallocene propylene-butene elastomers and crystalline propylene homopolymers to enhance heat sealing properties for flexible packaging purposes, and exhibiting particularly high seal strength retention in retort pouches post-retorting. An additional embodiment provides laminate structures of heat sealable polyolefin layers and propylene-butene metallocene elastomer blend layers for heat sealable applications in flexible packaging.

Preferably, the monoaxially oriented mono-layer film is produced via extrusion of the heat sealable layer blend through a die whereupon the molten film layer is quenched upon a chilled casting roll system or casting roll and water bath system and subsequently oriented in the machine direction and annealed or heat-set to minimize thermal shrinkage into a film.

In the embodiments of a monoaxially oriented multi-layer film, the laminate film is produced via coextrusion of the heat sealable layer blend and the core layer and/or other layers through a compositing die whereupon the molten multilayer film structure is quenched upon a chilled casting roll system or casting roll and water bath system and subsequently oriented in the machine direction and annealed or heat-set into a multi-layer film.

All these examples can also be metallized via vapor-deposition, preferably a vapor-deposited aluminum layer, with an optical density of at least about 1.5, preferably with an optical density of about 2.0 to 4.0, and even more preferably between 2.3 and 3.2.

A method to improve the heat sealability of monoaxially oriented films is provided resulting in an economical, highly sealable film with excellent directional tear properties suitable for retort packaging applications, and particularly exhibiting excellent heat seal strength retention after post-retorting. This helps solve the problems associated with the prior art of directional tear retortable polyolefin substrates in packaging applications.

Additional advantages will become readily apparent to those skilled in the art from the following detailed description, wherein only the preferred embodiments of this invention are shown and described, simply by way of illustration of the best mode contemplated for carrying out this invention. As will be realized, this invention is capable of other and different embodiments, and its details are capable of modifications in various obvious respects, all without departing from this invention. Accordingly, the examples and description are to be regarded as illustrative in nature and not as restrictive.

### BRIEF DESCRIPTION OF THE DRAWINGS

FIG. 1 is a diagram of a retort film pouch made using a laminate structure.

### DETAILED DESCRIPTION OF THE INVENTION

The above issues of making a sealable film with excellent sealing characteristics under retorting conditions and excellent directional and linear tear properties without using mechanical or laser perforation schemes or surface roughening and/or scoring methods are addressed.

The described films balance the above attributes of directional tear and heat sealablity by formulating an amount of 3-15 wt %, by weight of the film layer, of a metallocene-catalyzed propylene-butene copolymer of 15-30 wt % butene; 30-60 wt % of a crystalline propylene homopolymer; and with the remainder of the film composition including an impact copolymer resin of ca. 10-30% rubber content. It has been found that the addition of crystalline propylene homopolymer in an amount of 30-60 wt % of the film layer to the above formulation can provide significantly higher seal strengths to the retort pouch, particularly after the retorting process is completed on the filled pouch and cooled (“post-retort”). The directional tear property is imparted via machine direction (MD) orientation of the cast film from about 3 times to 7 times original length. This combination of MD orientation and resin formulation provides excellent directional tear properties without compromising the high seal strength and hermetic seal properties required for retort pouches.

In one embodiment, the laminate film includes a single-layer extruded film of: A mixed polyolefin resin layer including an isotactic ethylene-propylene impact copolymer; an amount of an amorphous metallocene-catalyzed propylene-butene elastomer; an amount of a crystalline propylene homopolymer; with an optional amount of amorphous metallocene-catalyzed ethylene-butene elastomer. Another embodiment of the inventive laminate film includes a similar formulation as above, except that one side of the polyolefin resin layer is discharge-treated.

The mixed polyolefin resin layer includes an isotactic ethylene-propylene impact copolymer of a specific rubber content blended with a crystalline propylene homopolymer or a “mini-random” crystalline propylene copolymer; and a minority amount of metallocene-catalyzed propylene-butene elastomer; and is uniaxially oriented. The amount of the impact copolymer to be used in the mixed polyolefin resin layer is about 40-70 wt % of the mixture, preferably about 40-50 wt %, and more preferably, about 43-48 wt %. The impact copolymer is an isotactic ethylene-propylene copolymer with an ethylene-propylene rubber content of about 10-30 wt % of the polymer wherein the ethylene content of the rubber is about 10-80 wt % of the rubber. Typically, the impact copolymer is manufactured in two reactors. In the first reactor, propylene homopolymer is produced and it is conveyed to the second reactor that also contains a high concentration of ethylene. The ethylene, in conjunction with the residual propylene left over from the first reactor, copolymerizes to form an ethylene-propylene rubber. The resultant product has two distinct phases: a continuous rigid propylene homopolymer matrix and a finely dispersed phase of ethylene-propylene rubber particles. The rubber content that is typically used is in the 10-30 wt % range depending on the desired end-use properties. It is this mixture of two phases—the propylene homopolymer matrix and the dispersed phase of ethylene-propylene rubber—that provides the impact resistance and toughening properties that impact copolymers are known for. Ethylene-propylene impact copolymers are distinctly different from conventional ethylene-propylene random copolymers which are typically polymerized in a single reactor, generally have a lower ethylene content (typically 0.5 wt % to 6 wt %) wherein the ethylene groups are randomly inserted by a catalyst along the polypropylene backbone chain, and do not include an ethylene-propylene rubber content.

A suitable example of ethylene-propylene impact copolymer is Total Petrochemical's 5571. This resin has a melt flow rate of about 7 g/10 minutes at 230° C., a melting point of about 160-165° C., a Vicat softening point of about 148° C., and a density of about 0.905 g/cm³. Another example of ethylene-propylene impact copolymer can be Total Petrochemical's 4180 with a melt flow rate of about 0.7 g/10 minutes at 230° C., a melting point of about 160-165° C., a Vicat softening point of about 150° C., and a density of about 0.905 g/cm³. Other suitable ethylene-propylene impact copolymers can be Braskem (formerly Sunoco) Petrochemical's TI-4015 with a melt flow rate of 1.6 g/10 minutes at 230° C. and a density of about 0.901 g/cm³ and ExxonMobil Chemical's PP7033E2 with a melt flow rate of about 8 g/10 minutes at 230° C. and a density of about 0.9 g/cm³.

The crystalline propylene homopolymer used in the mixed polyolefin layer formulation is an isotactic propylene homopolymer of typically 90% or greater isotactic content as determined by ¹³C NMR spectra obtained in 1,2,4-trichlorobenzene solutions at 130° C. The amount of crystalline propylene homopolymer to be used in the mixed polyolefin blend is about 30-60 wt % of the mixture, preferably about 40-55 wt %, and more preferably, about 46-53 wt %. The % isotactic content can be obtained by the intensity of the isotactic methyl group at 21.7 ppm versus the total (isotactic and atactic) methyl groups from 22 to 19.4 ppm. Suitable examples of crystalline propylene homopolymers are Total Petrochemical 3270, Total Petrochemical 3271, ConocoPhillips CH016, among others well-known in the industry. These resins have melt flow rates of about 0.5 to 5 g/10 min at 230° C., a melting point of about 159-167° C., a crystallization temperature of about 108-126° C., a heat of fusion of about 86-110 μg, a heat of crystallization of about 105-111 J/g, and a density of about 0.90-0.91. Also suitable are those crystalline propylene homopolymers that are well-known in the industry as “mini-random” propylene homopolymers in which said homopolymer is a specific type or subset of ethylene-propylene copolymer in which the ethylene content of the copolymer is less than 1.0 wt %, typically on the order of 0.2-0.7 wt % (these are also known as “fractional ethylene-propylene copolymers”) and is randomly inserted in the polymer backbone (as opposed to a block copolymer). In essence, said mini-random homopolymers perform and function similarly as true crystalline propylene homopolymers and can be used interchangeably in most cases and applications. Such mini-random homopolymers also have similar physical properties of isotactic content, melt flow rates, crystallinity, melting points, and densities as listed previously. Suitable mini-random propylene homopolymers can be those such as Total Petrochemical's 3374HA grade, ExxonMobil's PP4772 grade, or ConocoPhillips CR035 grade.

The metallocene-catalyzed propylene-butene elastomer used in the mixed polyolefin resin layer is blended with the suitable isotactic ethylene-propylene impact copolymer resin and the crystalline propylene homopolymer in an amount of 3-15 wt % of the layer, preferably 4-10 wt %, and more preferably about 4-8 wt %. This ratio of metallocene elastomer, crystalline homopolymer, and impact copolymer resins results in a good balance between heat seal initiation temperature, heat seal strengths, hermeticity in retorting applications, clarity, and low odor, particularly after machine direction orientation to impart directional tear characteristics, as well as retention of heat seal strengths after the retorting process is completed. The metallocene-catalyzed propylene-butene random elastomer preferably has 20-40 wt % butene content of the elastomer and the resulting polymer is amorphous or of low crystallinity, and is of very low density compared to typical polyethylenes, polypropylenes, and polybutenes. The metallocene catalysis of such elastomers results in a narrow molecular weight distribution; typically, M_{w}/Mₙ is 2.0 polydispersity. Comonomer dispersion is also narrower than in a comparable Ziegler-Natta catalyzed elastomer. This, in turn, results in an elastomer which provides lower seal initiation temperature and maintains high seal strength when used as a heat sealant modifier.

A thermoplastic elastomer can be described as any of a family of polymers or polymer blends (e.g. plastic and rubber mixtures) that resemble elastomers in that they are highly resilient and can be repeatedly stretched and, upon removal of stress, return to close to its original shape; is melt processable at an elevated temperature (uncrosslinked); and does not exhibit significant creep properties. Thermoplastic elastomers typically have a density between 0.860 and 0.890 g/cm³ and a molecular weight M_{w} of 100,000 or greater. “Plastomers” differ from elastomers: A plastomer can be defined as any of a family of ethylene-based copolymers (i.e. ethylene alpha-olefin copolymer) that have properties generally intermediate to those of thermoplastic materials and elastomeric materials (thus, the term “plastomer”) with a density of less than 0.900 g/cm³ (down to about 0.865 g/cm³) at a molecular weight M_{w} between about 5000 and 50,000, typically about 20,000 to 30,000.

Suitable and particularly preferred metallocene-catalyzed propylene-butene elastomer materials are such as those manufactured by Mitsui Chemicals under the tradename Tafmer® and grade names XM7070 and XM7080. These are propylene-butene low molecular weight, low crystallinity copolymers. XM7070 is about 26 wt % butene content; XM7080 is about 22 wt % butene. They are characterized by a melting point of 75° C. and 83° C., respectively; a Vicat softening point of 67° C. and 74° C., respectively; a density of 0.883-0.885 g/cm³; a T_{g} of about −15° C.; a melt flow rate at 230° C. of 7.0 g/10 minutes; and a molecular weight of 190,000-192,000 g/mol. XM7070 is preferred due to its higher butene content. The metallocene propylene-butene elastomers are in contrast to typical ethylene-propylene or propylene-butene or ethylene-propylene-butene random copolymers used for heat sealant resin layers in coextruded BOPP films such as Sumitomo SPX78H8 or Total Petrochemical's 8573, which are long-chain, high molecular weight polymers with significantly higher molecular weights on the order of 350,000 to 400,000 g/mol.

The metallocene propylene-butene elastomers are also in contrast to non-metallocene Ziegler-Natta catalyzed propylene-butene elastomers such as Mitsui Tafmer® XR110T. XR110T has a butene content of about 25.6 wt % and molecular weight of about 190,185 g/mol which is similar to XM7070, but its density of 0.89 g/cm³, melting point of 110° C., and Vicat softening point of 83° C. are all higher than its metallocene-catalyzed counterpart XM7070 butene-propylene elastomer. Additionally, due to the Ziegler catalyst system, the molecular weight distribution of the non-metallocene catalyzed butene-propylene elastomer XR110T is much wider than the metallocene-catalyzed butene-propylene elastomer XM7070. Consequently, the properties and heat sealable properties of a non-metallocene-catalyzed butene-propylene elastomer are much different from a metallocene-catalyzed butene-propylene elastomer.

An optional amount of a nucleating agent additive can also be used in the above formulation for the mixed polyolefin resin sealant layer. Such nucleating agents (sometimes also known in the industry as a “clarifying agent”) can be added to increase the crystallinity of propylene homopolymers or copolymers. The nucleating agents provide numerous nucleating sites for the propylene-based polymer to agglomerate and crystallize while in the molten state during extrusion and casting. Nucleating agents increase the onset of crystallization temperature, thus increasing the degree of crystallinity and speed of crystallization, and decreasing the average size and size range of spherulites. This also helps increase the stiffness and clarity of the film as well as reducing the impact strength slightly. Typically, nucleating agents include derivatives of benzoic acid such as sodium benzoate; naturally occurring minerals such as kaolin and talc; or dibenzylidene sorbitol. Nucleating agents are most conveniently added as a masterbatch of about 10 wt % active loading in the masterbatch. For the inventive formulations, a suitable amount of nucleating agent masterbatch is about 0.05-1.0 wt % of the mixed polyolefin resin layer, preferably about 0.2 wt % (or, in terms of active nucleating agent in a 10 wt % masterbatch, about 0.02 wt % active nucleating agent). A suitable and preferred nucleating agent masterbatch can be obtained from Ampacet Corporation's 403837 grade which uses a propylene homopolymer carrier resin and about 10 wt % (of the masterbatch) of Milliken Chemical's HPN-20E nucleating agent. The inventors have found that the addition of nucleating agent to the mixed polyolefin resin blend layer helped to improve pre- and post-retort seal strengths in retort pouch applications.

A further optional amount of a metallocene-catalyzed ethylene-butene copolymer elastomer can also be added to this polyolefin sealant blend of an amount up to 10 wt % of the layer. The addition of this metallocene ethylene-butene copolymer elastomer in addition to the metallocene propylene-butene copolymer elastomer can help to improve further seal initiation temperature properties, although the use of metallocene ethylene-butene elastomer can sacrifice overall heat seal strengths which may be critical in some retort packaging applications. A suitable and preferred metallocene-catalyzed ethylene-butene elastomer is Mitsui Tafmer® A4085S grade. A4085S has a butene content of about 15-35 wt % of the polymer, a melt flow rate of about 6.7 g/10 minutes at 230° C., melting point of about 75° C., Tg of about −65 to −50° C., Vicat softening point of about 67° C., and a density of about 0.885 g/cm³. A suitable amount of this metallocene ethylene-butene elastomer is 0% to about 10 wt % of the layer, preferably 3-4 wt % of the layer.

This mixed resin layer of impact copolymer, crystalline homopolymer, and metallocene elastomer (plus optional ingredients as desired) is typically 50 μM to 200 μm in thickness after monoaxial orientation, preferably between 60 μm and 150 μm, and more preferably between 70 μm and 100 μm in thickness. The mixed resin layer can also be surface treated on one side with an electrical corona-discharge treatment method, flame treatment, atmospheric plasma, or corona discharge in a controlled atmosphere of nitrogen, carbon dioxide, or a mixture thereof, with oxygen excluded and its presence minimized. The latter method of corona treatment in a controlled atmosphere of a mixture of nitrogen and carbon dioxide results in a treated surface that includes nitrogen-bearing functional groups, preferably at least 0.3 atomic % or more, and more preferably, at least 0.5 atomic % or more. The discharge-treated mixed resin layer is then well suited for subsequent purposes of laminating, coating, printing, or metallizing.

In this embodiment, it can be contemplated to add an optional amount of antiblocking agent to the mixed resin film layer for aiding machinability and winding. An amount of an inorganic antiblock agent can be added in the amount of 100-5,000 ppm of the core resin layer, preferably 500-1000 ppm. Preferred types of antiblock are spherical sodium aluminum calcium silicates or amorphous silica of nominal 6 μm average particle diameter, but other suitable spherical inorganic antiblocks can be used including crosslinked silicone polymer or polymethylmethacrylate, and ranging in size from 2 μm to 6 μm. Migratory slip agents such as fatty amides and/or silicone oils can also be optionally employed in the film layer either with or without the inorganic antiblocking additives to aid further with controlling coefficient of friction and web handling issues. Suitable types of fatty amides are those such as stearamide or erucamide and similar types, in amounts of 100-5000 ppm of the layer. Preferably, stearamide is used at 500-1000 ppm of the layer. A suitable silicone oil that can be used is a low molecular weight oil of 350 centistokes which blooms to the surface readily at a loading of 400-600 ppm of the layer. However, if the films are to be used for metallizing or high definition process printing, it is recommended that the use of migratory slip additives be avoided in order to maintain metallized barrier properties and adhesion or to maintain high printing quality in terms of ink adhesion and reduced ink dot gain.

In the embodiments in which a multi-layer film such as a 2-layer laminate film or a three-layer laminated film is contemplated, the mixed resin layer of the previously described impact copolymer, crystalline propylene homopolymer, and metallocene elastomers can be coextruded with another layer. In the embodiment of a 2-layer laminate film structure, the mixed resin layer (A) could include a sealant layer on one side of a core layer (B). Preferably, this core layer (B) includes a polyolefin resin-containing layer which in turn, includes a propylene homopolymer or propylene copolymer. More preferable is an ethylene-propylene impact copolymer of the same or similar type used as a component of the (A)-layer such as the previously described Total 5571 isotactic ethylene-propylene impact copolymer or other similar grades mentioned. The (A)-layer can be the same thickness as the (B) core layer, but preferably is thinner than the (B)-layer, about 5-50% of the total thickness of the (A) and (B) layers combined, more preferably 10-30% of the total thickness of the laminate film structure (A) and (B) layers combined. This core polyolefin resin-containing layer can also include an antiblock component selected from the group consisting of amorphous silicas, aluminosilicates, sodium calcium aluminum silicates, crosslinked silicone polymers, and polymethylmethacrylates to aid in machinability and winding. Migratory slip additives such as fatty amides or silicone oils could also be added as previously described if desired. It can also be contemplated to discharge-treat the side of the core layer (B) opposite the heat sealable layer (A) in order to enhance that side for laminating via adhesives, etc. Discharge-treating can be done by any of several means well known in the art, such as corona, flame, plasma, or discharge-treatment in a controlled atmosphere of selected gases as described previously.

In the embodiment of a 3-layer laminate film structure, a third layer (C) would be disposed on the side of the core layer (B) opposite the heat sealable mixed resin layer (A) and preferably includes a polyolefin resin-containing layer which in turn, includes a polyolefin selected from the group consisting of propylene homopolymer, copolymers, terpolymers, polyethylene and combinations thereof. This third layer (C) will generally be thinner than the core layer (B) and can be a thickness ranging 2-30% of the combined thickness of the 3 layers together, preferably about 5-10% of the overall thickness of the multi-layer laminate. This third polyolefin resin-containing layer can also include an antiblock component selected from the group consisting of amorphous silicas, aluminosilicates, sodium calcium aluminum silicates, crosslinked silicone polymers, and polymethylmethacrylates to aid in machinability and winding and/or migratory slip additives such as fatty amides or silicone oils. The third polyolefin layer can also be a discharge-treated layer having a surface for lamination, metallizing, printing, or coating with adhesives or other materials.

An embodiment of a mono-axially oriented polyolefin film may including a heat sealable layer comprising 25-67 wt % of an ethylene-propylene impact copolymer, 3-15 wt % of a metallocene-catalyzed propylene-butene elastomer, and 30-60 wt % of a crystalline propylene homopolymer, wherein the film is oriented at least 3 times in a machine direction.

An embodiment of a laminate retort pouch may include a heat sealable layer including 25-67 wt % of a mono-axially oriented polyolefin film including an ethylene-propylene impact copolymer blended with 3-15 wt % of a metallocene-catalyzed propylene-butene elastomer and 30-60 wt % of a crystalline propylene homopolymer; oriented at least 3 times in the machine direction; and a gas barrier layer. The laminate retort pouch may further include a nylon film layer, an ink receiving layer, and an adhesive to bond layers of the laminate pouch together.

An embodiment of a method of making a mono-axially oriented polyolefin film may include extruding a film including a heat sealable layer including 25-67 wt % of an ethylene-propylene impact copolymer, 3-15 wt % of a metallocene-catalyzed propylene-butene elastomer, and 30-60 wt % of a crystalline propylene homopolymer; and mono-axially orienting the film at least 3 times in the machine direction. The film may be a single or multi layer co-extruded film.

In all these embodiments, a key element is to monoaxially orient the film layer in the machine direction to a certain amount. It is this monoaxial orientation that imparts the directional or linear tearing properties that make it useful in pouching applications. It is the combination of this monoaxial orientation with the heat sealable resin formulation of isotactic ethylene-propylene impact copolymer of specified rubber content and ethylene content, metallocene-catalyzed propylene-butene elastomer of specific butene content, and crystalline propylene homopolymer that allows excellent and suitable heat seal initiation and seal strengths fit-for-use in retort pouch applications and excellent directional and linear tear properties. The amount of monoaxial machine direction orientation should be about 3-7 times in the machine direction, preferably 4-7 times, and more preferably 4.8 to 6.0 times. Suitably clean and linear tear properties are found at these monoaxial orientation rates. However, above a 7:1 machine direction orientation ratio, processability issues may result such as film breakage which can affect the product cost and machine efficiency; below a 3:1 machine direction orientation ratio, processability issues such as uneven film profile, gauge bands, and uneven stretch marks can occur which also can result in higher product costs and lower machine efficiencies.

In the above embodiments of multi-layer films, the respective layers can be coextruded through a multi-layer compositing die such as a 2- or 3-layer die, and cast onto a chill roll to form a solid film suitable for further processing. In the case of a single layer film, the respective layer is extruded through a single-layer die and cast onto a chill roll to form a solid film suitable for further processing. Extrusion temperatures are typically set at 235-270° C. with a resulting melt temperature at the die of about 230-250° C. In these embodiments, the individual resin components may be dry-blended as pellets together in a mixer prior to feeding to the extruder so as to have good dispersion of the components; alternatively, the individual resin components may also be melt-compounded together and pelletized prior to feeding into the extruder (although the latter adds cost, it generally ensures better mixing and dispersion of the individual components throughout the mixture).

The extruded sheet is cast onto a cooling drum at a speed of 6 to 15 mpm whose surface temperature is controlled between 18° C. and 60° C. to solidify the non-oriented laminate sheet. The non-oriented laminate sheet is stretched in the longitudinal direction at about 90° C. to 130° C. at a stretching ratio of about 3 to about 7 times the original length, and most preferably between about 3.8 and 4.1 times, and the resulting stretched sheet is annealed or heat-set at about 130° C. to 150° C. in the final zones of the machine direction orientation section to reduce internal stresses and minimize thermal shrinkage and to obtain a dimensionally stable uniaxially oriented laminate sheet. After orientation, the typical film thickness is 50-200 μm and most preferably, 70-100 μm. The uniaxially oriented sheet can then pass through a discharge-treatment process on one side of the film such as an electrical corona discharge treater to impart a suitable surface for lamination to other films as desired. The one-side treated film is then wound into roll form.

One embodiment is to metallize the discharge-treated surface of the resin blend layer. The unmetallized laminate sheet is first wound in a roll. The roll is placed in a metallizing chamber and the metal vapor-deposited on the discharge-treated mixed resin metal receiving layer surface. The metal film may include titanium, vanadium, chromium, manganese, iron, cobalt, nickel, copper, zinc, aluminum, gold, or palladium, the preferred being aluminum. Metal oxides can also be contemplated, the preferred being aluminum oxide. The metal layer can have a thickness between 5 and 100 nm, preferably between 20 and 80 nm, more preferably between 30 and 60 nm; and an optical density between 1.5 and 5.0, preferably between 2.0 and 4.0, more preferably between 2.3 and 3.2. The metallized film is then tested for oxygen and moisture gas permeability, optical density, metal adhesion, metal appearance and gloss, and can be made into an adhesive laminate structure.

This invention will be better understood with reference to the following examples, which are intended to illustrate specific embodiments within the overall scope of the invention.

### RETORT FILM POUCH EXAMPLES

To confirm the films are suitable for the use in retort pouching, the following method was performed:

1) The MD-oriented Example film was adhesively laminated with an aluminum oxide (AlOx) deposited biaxially oriented polyethylene terephthalate (PET) film having a thickness of 12 μm (e.g. Toray Advanced Film Co.'s Barrialox™ 1101 HG-CX) and a commercially available biaxially oriented nylon film having a thickness of 15 μm into a final laminate structure of PET/AlOx/adhesive/nylon/adhesive/Example film of interest (whose corona treated side was faced toward the adhesive). The adhesive used was a commercially available retort grade two-component adhesive (e.g. Dow Adcote 812 with crosslinker 9L19); typical target thickness of the adhesive was 3.5 μm after drying.

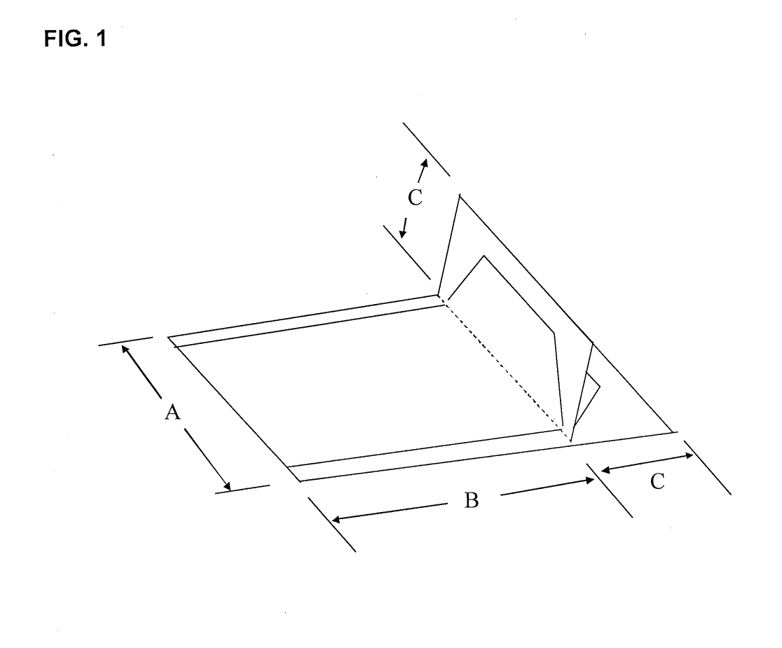

2) A pouch was made using the said laminate structure such that the Example film was arranged to be the inside surface of the pouch. The dimensions of the pouch can be specified as desired for the particular application of food-type and/or pouch-making machine or sealing machine, but an example pouch size can be as follows and shown in FIG. 1 with the following dimensions: pouch bottom A=120 mm, pouch sides B=100 mm, and pouch top or mouth C=55 mm. The pouch is made by folding over the laminate film to form the bottom of the pouch (“A”); the sides of the pouch (“B”) are heat-sealed at suitable conditions to ensure a strong weld (see “Test Methods” for example sealing temperatures and conditions) with the heat-sealed area of about 12-13 mm in width; and the mouth or top of the pouch (“C”) was left open.

3) The pouch was filled with about 200 g of distilled water and the mouth or top of the pouch (“C”) was totally sealed. (If desired, foodstuffs may also be used such as pet food or vegetables or stews or soups.) The filled pouch was subjected to retort sterilization condition of 120° C. for 30 minutes.

4) After the pouch was allowed to cool to room temperature, the pouch was cut open at the bottom of the pouch (“A”) and the contents discharged. The pouch's side seals “B” and the top seal “C” was tested for “post-retort” seal strength. The desired post-retort seal strength of the side and top seals made from the Examples was minimum 35 N/15 mm (5950 g/25 mm) and preferably about 45 N/15 mm (7650 g/25 mm).

5) The test pouches were also sealed with contents as in step 3 but not subjected to retorting conditions. In this case, the contents were discharged after sealing top seal area “C” and the side seals “B” and top seal “C” were tested for seal strengths for evaluation of “pre-retort” seal strengths. Desired values for pre-retort seal strengths were typically about 45 N/15 mm (7650 g/25 mm).

6) A notch can be made in either side of the pouch's side seals “B” simply by using scissors to snip a small slit on the edge of the side seal. The slit should not extend through the width of the sealed area and into the pouch interior; otherwise, this would compromise the integrity of the sealed pouch and allow its contents to become contaminated or leak out. This slit or notch can then be used to evaluate the directional tear properties of the example pouch as described in the “Test Methods” section of this application.

### Example 1

A single-layer extrusion article including a mixed resin layer of an ethylene-propylene impact copolymer Braskem TI-4015 at about 48 wt % of the layer, crystalline propylene homopolymer Total 3271 at about 48 wt %, and about 4 wt % of metallocene-catalyzed propylene-butene elastomer Mitsui XM7070 was extruded and cast and monoaxially oriented in the machine direction at a 4.0:1.0 stretch ratio. The resin components were dry-blended together and extruded in a single-screw extruder and cast using a matte finish chill roll. The total thickness of this film substrate after monoaxial orientation was ca. 70 p.m. The film was passed through a corona treater for discharge treatment on one side of the film and wound into roll form. The film was tested for directional tear performance, haze, and heat sealability properties. The Example film was than adhesively laminated to an aluminum oxide coated PET film and a biaxially oriented nylon film and made into pouches for retorting purposes as described previously. The Example film includes the interior surface of the pouch. The pouch was then filled with water and retorted at 120° C. for 30 minutes, allowed to cool, and then the side and top seals were tested for seal strengths for post-retort values. In addition, the pouch's side and top seals were also tested for seal strengths prior to retorting to obtain pre-retort values. Directional tear properties were also evaluated on both the unlaminated Example film and the pouch made of the Example film.

### Example 2

Example 1 was repeated except that the mixed resin layer was changed to about 46 wt % Braskem TI-4015 impact copolymer, about 46 wt % Total 3271 homopolymer, and about 8 wt % Mitsui XM7070 metallocene elastomer.

### Example 3

Example 1 was repeated except that the mixed resin layer was changed to about 43 wt % Braskem TI-4015 impact copolymer, about 53 wt % Total 3271 homopolymer, and about 4 wt % Mitsui XM7070 metallocene elastomer.

### Example 4

Example 1 was repeated except that the mixed resin layer was changed to about 47.9 wt % Braskem TI-4015 impact copolymer, about 47.9 wt % Total 3271 homopolymer, about 4 wt % Mitsui XM7070 metallocene elastomer, and also contained about 0.2 wt % of a nucleating agent masterbatch Ampacet 403837.

### Comparative Example 1

A single-layer extrusion article including a mixed resin layer of an ethylene-propylene impact copolymer Braskem TI-4015 at 92 wt % of the layer and 8 wt % of metallocene-catalyzed propylene-butene elastomer Mitsui XM7070 was extruded and cast and monoaxially oriented in the machine direction at a 4.0:1.0 stretch ratio. No crystalline propylene homopolymer was used in this example. The resin components were dry-blended together and extruded in a single-screw extruder and cast using a matte finish chill roll. The total thickness of this film substrate after monoaxial orientation was ca. 70 μm. The film was passed through a corona treater for discharge treatment on one side of the film and wound into roll form. The film and pouch made from the comparative example film was tested for directional tear performance, haze, and heat scalability properties.

### Comparative Example 2

Comparative Example 1 was repeated except that it was not oriented in the machine direction; i.e. the machine direction orientation was at a 1.0:1.0 stretch ratio.

The properties of the Examples and Comparative Examples (“CEx.”) are shown in Table 1.

TABLE 1

| | | | | | | | Pre-Retort | | Post-Retort | |
|---|---|---|---|---|---|---|---|---|---|---|
| | | | | | | | Seal Strength | | Seal Strength | |
| | Film Layer Composition wt % | | | | | Directional | (N/15 mm) | | (N/15 mm) | |
| | Braskem | Tafmer | Total | Ampacet | | Tear | Side | | Side | Top |
| Sample | 4015 | XM7070 | 3271 | 403387 | MDX | (Rating) | Seal | Top Seal | Seal | Seal |
| Ex. 1 | 48 | 4 | 48 | 0 | 4.0:1.0 | 1 | 47.1 | 44.0 | 35.8 | 35.0 |
| Ex. 2 | 46 | 8 | 46 | 0 | 4.0:1.0 | 1 | 52.2 | 47.9 | 41.6 | 38.6 |
| Ex. 3 | 43 | 4 | 53 | 0 | 4.0:1.0 | 1 | 52.0 | 45.1 | 42.5 | 40.2 |
| Ex. 4 | 47.9 | 4 | 47.9 | 0.2 | 4.0:1.0 | 1 | 49.3 | 45.6 | 37.2 | 38.1 |
| CEx. 1 | 92 | 8 | 0 | 0 | 4.0:1.0 | 1 | 44.8 | 39.7 | 30.8 | 25.2 |
| CEx. 2 | 92 | 8 | 0 | 0 | 1.0:1.0 | 5 | 63.8 | 58.1 | 52.7 | 50.1 |

As the Table shows, Comparative Example 2 (CEx 2) was a non-oriented film using the formulation blend of impact copolymer Braskem T14015 and metallocene propylene-butene elastomer Tafmer XM7070 at 92% and 8% of the weight of the film, respectively. This composition had excellent pre- and post-retort seal strengths for both side and top seals of the pouch, well above the desired minimum of 35 N/15 mm. However, when a film sheet was torn by hand at a notch along the machine direction, the appearance of the tear initiation point showed stress-whitening and deformation, and the torn edge was irregular and often zippered down the face of the sheet at an angle instead of parallel to the machine direction. Tear performance was rated a “5”; CEx 2's directional tear was considered to be poor.

Comparative Example 1 (CEx 1) was oriented in the machine direction at a stretch ratio of 4.0:1.0 and showed excellent directional tear properties and was rated a “1”. Tear was even and parallel to the pouch top and no stress-whitening observed. However, although pre-retort pouch top and side seal strengths were good (i.e. above 35 N/15 mm), they were noticeably lower than CEx 2's results. This indicated the loss of seal strength performance due to the machine direction orientation for improved tear property. Moreover, after retorting, post-retort side and top seal strengths of the pouch were noticeably lower than pre-retort values and below the desired value of 35 N/15 mm. The post-retort seal strengths of this Example were considered unsatisfactory.

Example 1 (Ex 1) showed a film that used a formulation including the Braskem impact copolymer, the Mitsui metallocene elastomer, and the Total crystalline propylene homopolymer as shown in the Table. This Example was monoaxially oriented at 4.0 MDX stretch ratio. This example's pre- and post-retort side and top heat seal strengths were satisfactory and met the desired target of 35 N/15 mm or better. Moreover, directional tear remained extremely good with the tear propagating cleanly from the notch with no stress-whitening or deformation, and the tear itself being very straight-edged and parallel to the machine direction of the sheet and was rated a “1”. Ex. 1's directional tear was considered to be excellent and its pre- and post-retort heat seal performance acceptable.

Example 2 (Ex 2) showed a film that used a similar formulation as Ex 1 but with slightly different proportions of the impact copolymer, propylene homopolymer, and metallocene elastomer, and was monoaxially oriented at 4.0 MDX stretch ratio. This Example's pre- and post-retort side and top heat seal strengths remained very good and fit-for-use, and improved over Ex 1's seal strength performance. Directional tear was extremely good (rated “1”) with the tear propagating cleanly from the notch with no stress-whitening or deformation, and the tear itself being very straight-edged and parallel to the machine direction of the sheet.

Example 3 (Ex 3) showed a film that used a similar formulation as Ex 1 but had a higher amount of crystalline homopolymer at 53 wt % and a lower amount of impact copolymer at 43 wt %. Ex 3 was monoaxially oriented at 4.0 MDX stretch ratio. This Example's pre- and post-retort side and top heat seal strengths were very good and remained fit-for-use; Ex 3 exhibited further improvement in post-retort seal performance over Ex 1 and Ex 2. Directional tear was also extremely good (rated “1”) with the tear propagating cleanly from the notch with no stress-whitening or deformation, and the tear itself being very straight-edged and parallel to the machine direction of the sheet.

Example 4 was similar to Ex 1's formulation except that an amount of nucleating agent masterbatch was added at about 0.2 wt %. The addition of this nucleating agent appeared to improve pre- and post-retort top and side seal strength performance over Ex 1. Directional tear remained very good, being rated a “1”.

Thus, the foregoing Examples showed a way to maintain high pre- and post-retort seal strengths which were important in the use of retort pouching where high and hermetic seal strengths were needed to withstand the internal pouch pressure that resulted from retort cooking/sterilization and yet provided the desirable attribute of directional tear that was imparted from orientation stretching of the film. Since it would be expected that seal performance would be worsened after orientation of the film, these films unexpectedly showed excellent seal performance with orientation of the film and maintained excellent pre- and post-retort seal strengths.

### Test Methods

The various properties in the above examples were measured by the following methods: Heat seal strength: Measured by using a Sentinel sealer model 12 ASL at 25 psi (ca. 17.2 N/cm²), 1.0 second dwell time, with heated flat upper seal jaw Teflon coated, and unheated lower seal jaw, rubber with glass cloth covered. The film sample is heat-sealed to itself at the desired seal temperature(s) in the Sentinel sealer (e.g. 310° F. or 154.4° C.). To prevent the film from sticking to the sealer's jaws, the test film can be laid onto a heat-resistant film such as a biaxially oriented nylon or polyethylene terephthalate film (PET). These two films are then folded over such that the nylon or PET film is outermost and in contact with the heated sealer jaws; the test film is then the inner layer and will seal to itself upon application of heat and pressure. A 15-20 μm thick nylon or PET film is recommended; if too thick, this may interfere with thermal transfer to the test film. The test film should be inserted between the heat sealer's jaws such that the film's machine direction is perpendicular to the heat sealer jaws. Heat seal temperatures may be increased at desired intervals, e.g. 10° F. (5.56° C.) increments. The respective seal strengths are measured using an Instron model 4201 tensile tester. The heat-sealed film samples are cut into 1-inch (ca. 25.4 mm) wide strips along the machine direction; the two unsealed tails placed in the upper and lower Instron clamps, and the sealed tail supported at a 90° angle to the two unsealed tails for a 90° T-peel test. The peak and average seal strength is recorded. The preferred value is minimum 5950 Win (ca. 35 N/15 mm) at 350° F. (ca. 176.7° C.) seal temperature for both pre- and post-retort conditions.

For measuring the heat seal strength of the already-formed pouches, the pouch was cut apart parallel to the side seals and parallel to the top seal, leaving tails or wings on each side of the sealed area. The sealed areas were then cut crosswise in ca. 1″ or 25.4 mm wide sections. The two tails of the sealed section were placed in the Instron 4201 jaws and peak and average seal strengths recorded.

Seal initiation temperature: Heat seal initiation temperature (SIT) was measured by using a Sentinel sealer model 12 ASL at 25 psi (ca. 17.2 N/cm²), 1.0 second dwell time, with heated flat upper seal jaw Teflon coated, and unheated lower seal jaw, rubber with glass-cloth covered. The film sample is heat-sealed to itself at various desired seal temperatures in the Sentinel sealer and then the respective seal strengths are measured using an Instron model 4201 tensile tester as discussed above for heat seal strength determination. The Seal Initiation Temperature is defined as the seal temperature at which the film demonstrated a minimum of 2000 g/in (ca. 11.76 N/15 mm) heat seal strength. The preferred SIT value is maximum 330° F. (ca. 165.56° C.) or lower.

Transparency of the film was measured by measuring haze of a single sheet of film substantially in accordance with ASTM D1003. Preferred haze value is 75% or less.

Directional tear is tested qualitatively by notching a piece of test film on the edge and tearing by hand at the notch to initiate the tear. The notch is made parallel to the machine direction and the tear will be propagated along the machine direction. The tear is initiated from the notch by hand and observation made as to whether any stress-whitening or deformation occurs. As the tear is propagated, the consistency of the torn edges and the angle at which the tear propagates is observed. The preferred observation for good directional tear property is: 1) no stress-whitening or deformation; 2) torn edges are consistent and propagates cleanly; 3) the tear propagates in a straight line from the notch across the width of the sheet parallel to the machine direction. If the tear initiation at the notch shows stress-whitening or deformation; and/or the tear propagation is ragged, or is non-linear or non-parallel to the machine direction of the film, is propagated at an angle to the machine direction edge of the film; then this in considered to be unacceptable for directional or linear tear properties. This directional tear property was qualitatively categorized and ranking established as follows:

Rank 1 (Excellent): no stress-whitening or deformation, torn edges are consistent and propagate cleanly; the tear propagates in a straight line from the notch across the width of the sheet parallel to the machine direction.

Rank 2 (Good): torn edges are consistent and propagate cleanly; the tear propagates most likely (more than 90%) in a straight line from the notch across the width of the sheet parallel to the machine direction. No stress-whitening or deformation is observed.

Rank 3 (Marginal): torn edges are consistent and propagate cleanly; the tear propagates likely (more than 80%) in a straight line from the notch across the width of the sheet parallel to the machine direction. Few stress-whitening or deformation is observed occasionally.

Rank 4 (Not acceptable): stress-whitening or deformation is likely observed, torn edges are not consistent and do not propagate cleanly, the tear often propagates in an angled direction from the desired (machine) direction.

Rank 5 (Bad): the tear initiation at the notch shows stress-whitening or deformation; and/or the tear propagation is ragged, or is non-linear or non-parallel to the machine direction of the film, is propagated at an angle to the machine direction edge of the film

Wetting tension of the surfaces of interest was measured substantially in accordance with ASTM D2578-67. In general, the preferred value was an average value equal to or more than 40 dyne/cm (400 μN) with a minimum of 38 dyne/cm (380 μN).

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

We claim:

1. A mono-axially oriented polyolefin film comprising:
a heat sealable layer comprising 25-67 wt % of an ethylene-propylene impact copolymer, 3-15 wt % of a metallocene-catalyzed propylene-butene elastomer, and 30-60 wt % of a crystalline propylene homopolymer, wherein the film is oriented at least 3 times in a machine direction.

2. The film of claim 1, wherein the ethylene-propylene impact copolymer has a rubber content of 10-30%.

3. The film of claim 1, wherein the heat sealable layer further comprises a metallocene-catalyzed ethylene-butene elastomer with a butene content of 15-35%.

4. The film of claim 1, wherein the metallocene-catalyzed propylene-butene elastomer has a butene content of 15-30 wt %.

5. The film of claim 1, wherein the film is a single layer film.

6. The film of claim 1, further comprising a second polyolefin layer.

7. The film of claim 6, wherein the second polyolefin layer comprises a propylene homopolymer or a propylene copolymer.

8. The film of claim 6, wherein the second polyolefin layer comprises an ethylene-propylene impact polymer.

9. The film of claim 6, wherein the second polyolefin layer further comprises an antiblock component selected from the group consisting of amorphous silicas, aluminosilicates, sodium calcium aluminum silicates, crosslinked silicone polymers, and polymethylmethacrylates.

10. The film of claim 6, further comprising a third polyolefin layer disposed on a side of the second polyolefin layer opposite the heat sealable layer.

11. The film of claim 10, wherein the third polyolefin layer comprises a polyolefin selected from the group consisting of propylene homopolymer, propylene copolymers, propylene terpolymers, and polyethylene.

12. The film of claim 10, wherein the third polyolefin layer further comprises an antiblock component selected from the group consisting of amorphous silicas, aluminosilicates, sodium calcium aluminum silicates, crosslinked silicone polymers, and polymethylmethacrylates.

13. The film of claim 6, further comprising a metal layer on a side of the second polyolefin layer.

14. The film of claim 10, further comprising a metal layer of a side of the third polyolefin layer.

15. A retort package comprising the film of claim 1.

16. A laminate retort pouch comprising:
a heat sealable layer comprising 25-67 wt % of a mono-axially oriented polyolefin film comprising an ethylene-propylene impact copolymer blended with 3-15 wt % of a metallocene-catalyzed propylene-butene elastomer and 30-60 wt % of a crystalline propylene homopolymer; oriented at least 3 times in the machine direction; and
a gas barrier layer.

17. The laminate retort pouch of claim 16, further comprising a nylon film layer.

18. The laminate retort pouch of claim 16, further comprising an ink receiving layer.

19. The laminate retort pouch of claim 16, further comprising an adhesive to bond layers of the laminate pouch together.

20. A method of making a mono-axially oriented polyolefin film comprising:
extruding a film comprising a heat sealable layer comprising 25-67 wt % of an ethylene-propylene impact copolymer, 3-15 wt % of a metallocene-catalyzed propylene-butene elastomer, and 30-60 wt % of a crystalline propylene homopolymer; and
mono-axially orienting the film at least 3 times in the machine direction.

21. The method of claim 20, wherein the film is a single layer film.

22. The method of claim 21, further comprising discharge treating a surface of the film.

23. The method of claim 20, wherein the film comprises multiple co-extruded layers.

24. The method of claim 23, further comprising discharge treating a surface of the film.

25. The method of claim 24, further comprising vacuum-depositing a metal layer on the discharge-treated surface.
